(19) United States
(12) Patent Application Publication
(10) Pub. No.: US 2013/0060744 A1
(43) Pub. Date: Mar. 7, 2013

(54) Personalized Event Search Experience using Social data

(71) Applicants: Subrata Roychoudhuri, Hyderabad (IN); Sarabjit Singh Seera, Hyderabad (IN); Phanindra Kanumuri, Hyderabad (IN); Suresh Iyengar, Hyderabad (IN); Pratik Stephen, Hyderabad (IN)

(72) Inventors: Subrata Roychoudhuri, Hyderabad (IN); Sarabjit Singh Seera, Hyderabad (IN); Phanindra Kanumuri, Hyderabad (IN); Suresh Iyengar, Hyderabad (IN); Pratik Stephen, Hyderabad (IN)

(73) Assignee: MICROSOFT CORPORATION, Redmond, WA (US)

(21) Appl. No.: 13/226,502

(22) Filed: Sep. 7, 2011

(51) Int. Cl. G06F 17/30

(52) U.S. Cl. 707/706; 707/723; 707/E17.084; 707/E17.108

(57) ABSTRACT

Aspects of the subject matter described herein relate to social event searching. In aspects, a search engine may receive a query regarding a social event. The search engine may obtain static data that indicates a ranking of the event based on overall popularity and may change the ranking based on social data that is particular to the user issuing the query. The search results may be ordered by the ranking and returned together with other social data to a search component such as a Web browser. The Web browser may then display the results together with the other social data. The Web browser may receive additional input from the user regarding preferences and may provide the input to a backend system for use to satisfy subsequent social event queries.

### BACKGROUND

People often use search engines to search for concerts or other social events of interest in their area. A search engine may use generic impersonal heuristics that are not very relevant to the person using the search engine. Consequently, the search results may not be as useful as they could be for the person using the search engine.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to social event searching. In aspects, a search engine may receive a query regarding a social event. The search engine may obtain static data that indicates a ranking of the event based on overall popularity and may change the ranking based on social data that is particular to the user issuing the query. The search results may be ordered by the ranking and returned together with other social data to a search component such as a Web browser. The Web browser may then display the results together with the other social data. The Web browser may receive additional input from the user regarding preferences and may provide the input to a backend system for use to satisfy subsequent social event, queries.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that represents a data collector for event data in accordance with aspects of the subject matter described herein;

FIG. 3 is a block diagram that represents a data collector for social data in accordance with aspects of the subject matter described herein;

FIG. 4 is a block diagram that generally represents an exemplary system for collecting and aggregating data in accordance with aspects of the subject matter described herein;

FIG. 5 is a block diagram illustrating an exemplary system that combines static results with personal and dynamic information in accordance with aspects of the subject matter described herein;

FIG. 6 is a block diagram of an exemplary user interface window in accordance with aspects of the subject matter described herein;

FIG. 7 is a block diagram that illustrates data sharing among a search engine, social data providers, and a search interface in accordance with aspects of the subject matter described herein;

FIGS. 8-9 are flow diagrams that generally represent exemplary actions that may occur in accordance with aspects of the subject matter described herein; and

FIG. 10 is a block diagram that illustrates an exemplary system configured in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional, context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

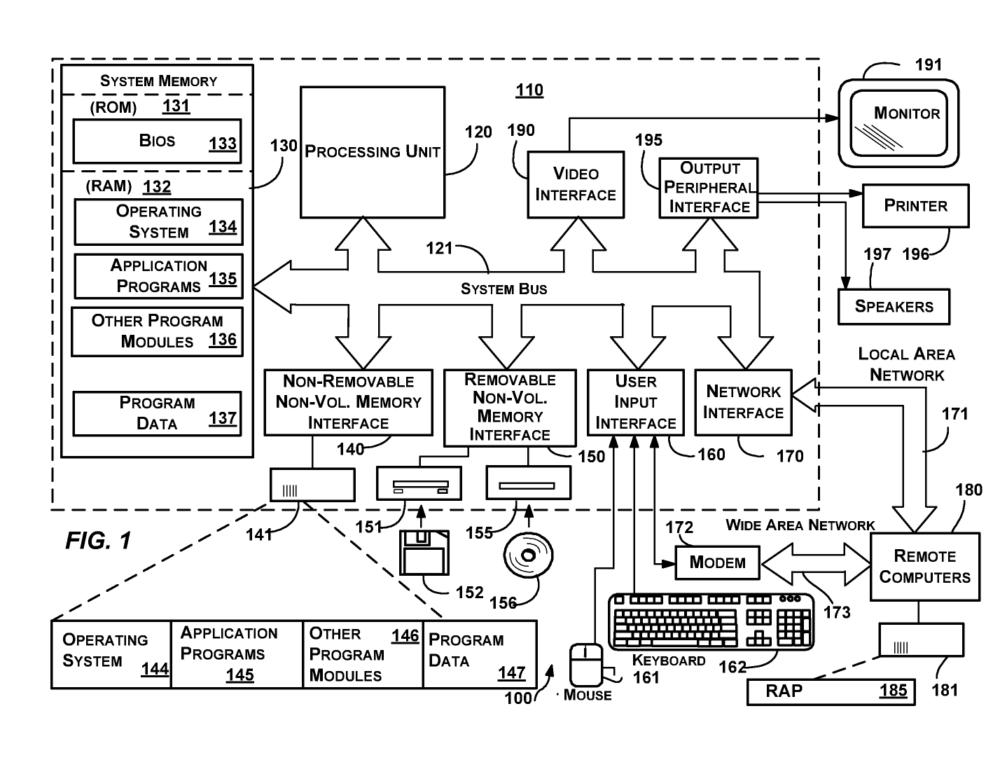

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel. Architecture (MCA) bus, Enhanced ISA (EISA) bus, Video Electronics Standards Association (VESA) local bus, Peripheral Component Interconnect (PCI) bus also known as Mezzanine bus, Peripheral Component. Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RPM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state PAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Personalized Search Experience

As mentioned previously, search engines may use generic impersonal heuristics that are not highly relevant to some users. As used herein, social events refer to events that involve people. For example, a game, concert, party, or other event that involves people may be considered social events.

Aspects of the subject matter described herein relate to:

1. Fetching and aggregating data from social networks into a queryable data structure;

2. Creating and maintaining a queryable data structure that may be used to provide social signal ordered records in response to eventing queries;

3. A dynamic system that may be used to overlay results from item 2 above with personal data and freshly available data;

4. A user interface that uses personal aspects of results served for events queries;

5. A system that uses a cycle of participation and refinement of data.

The items above (and others) are described in more detail below.

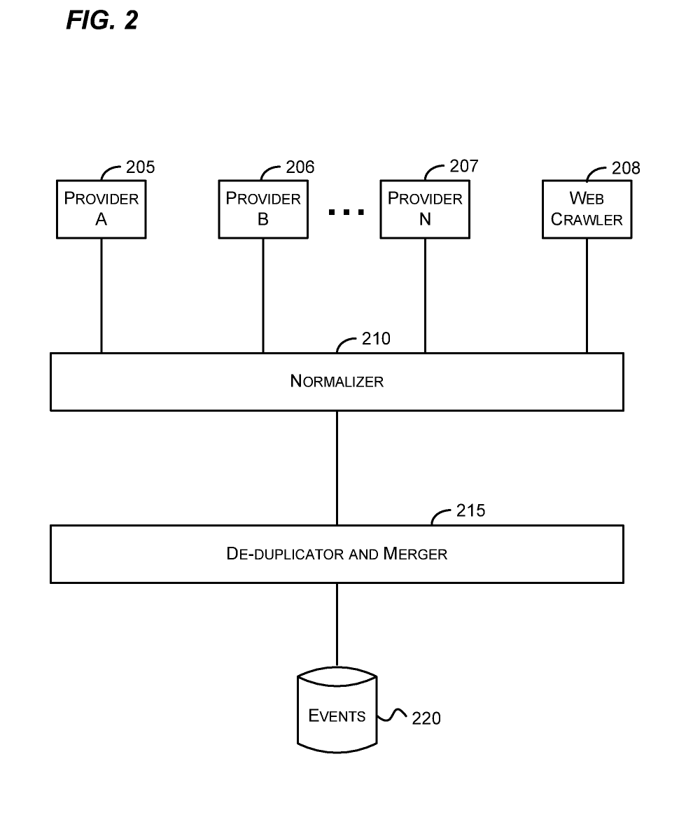

FIGS. 2-7 and 10 include components that may be used in exemplary implementations. The components illustrated in FIGS. 2-7 and 10 are exemplary and are not meant to be all-inclusive of components that may be needed or included. In other embodiments, the components described in conjunction with FIGS. 2-7 and 10 may be included in other components (shown or not shown) or placed in subcomponents without departing from the spirit or scope of aspects of the subject matter described herein.

As used herein, the term component is to be read to include hardware such as all or a portion of a device, a collection of one or more software modules or portions thereof, some combination of one or more software modules or portions thereof and one or more devices, or portions thereof, and the like.

Fetching and Aggregating Data. FIG. 2 is a block diagram that represents a data collector for event data in accordance with aspects of the subject matter described herein. Turning to FIG. 2, the data collector may include providers 205-207, a Web crawler 208, a normalizer 210, a de-duplicator and merger 215, and a data store 220. The providers 205-207 and Web crawler 208 provide event data to the normalizer 210. The providers 205-207 and the Web crawler 208 may provide data in different formats and using different schemes. The normalizer 210 takes this data and converts it into a common scheme. After converting the data to a common scheme, the normalizer 210 may provide the data to the de-duplicator and merger 215.

The de-duplicator and merger 215 combines the data provided to it and removes redundancies. For example, data about two different events may be merged into a table, other data structure, or other form (e.g., a text file such as a corpus) that includes data about events. Duplicate data from multiple providers about a single event may be discarded.

The data produced by the de-duplicator and merger 215 may be stored in the data store 220 and published to a data index. The data index may be queried on various attributes including, for example, event identifier, event name, performer name, date range, venue name, and the like, and categories including, for example, music, location name, and the like.

The providers 205-207 may provide event data in different formats. The components of FIG. 2 may extract this data and put it into a canonical schema. Some exemplary canonical event schema include:

string eventName

string startDate

string startiime

optional string endDate

optional string endTime

optional string description

optional string priceRange

optional list<string> categories

optional list<string> imageLinks

string venuename

string venueaddr

Two exemplary event feeds are as follows:

| | |
|---|---|
| Sample Feed 1 | Sample Feed 2 |

| | |
|---|---|
| <events> | <events> |
| <event> | <evt:1> |

| | |
|---|---|
| <name> Wicked </name> | <ename> Wicked the Musical </ename> |
| <date> | <startdate>06/22/2011</startdate> |

| | |
|---|---|
| <start>22^{nd} July 2011</start> | <pricerange>$100 to $220 </pricerange> |

| | |
|---|---|
| </date> | <desc>.....</desc> |
| <description>.....</description> | <categories> |

| | |
|---|---|
| <price> | <category>Performing Arts</category> |

| | |
|---|---|
| <from>$100</from> | </categories> |
| <to>$200</to> | <venueAddr>Gershwin Theatre, New |

| | |
|---|---|
| </price> | York</venueAddr> |

| | |
|---|---|
| <categories> | .... |

| | |
|---|---|
| <cat>Music</cat> | </evt:1> |
| <cat>Performing Arts</cat> | <evt:2> |

| | |
|---|---|
| </categories> | <ename> Wicked the Musical </ename> |
| <venue> | <startdate>06/24/2011</startdate> |
| <name>Gershwin Theatre</name> | <pricerange>$150 to $200 </pricerange> |
| </venue> | <desc>.....</desc> |
| <reviews> | <categories> |

| | |
|---|---|
| <review>...</review> | <category>Music concert</category> |

| | |
|---|---|
| <review>...</review> | </categories> |
| </review> | <venueAddr>Gershwin Theatre, New |

| | |
|---|---|
| .... | York</venueAddr> |

| | |
|---|---|
| </event> | .... |
| </events> | </evt:2> |
| | </events> |

Following are some examples of attribute normalization:

1. Event names “Detroit International Jazz Festival” is same as “Detroit jazz fest”, “16th Annual Telluride Blues & Brews Festival” is same as “telluride blues and brews”

2. Special day “St. Patrick's day” is same as “paddy's day” or “saint paddy's”, “Christmas” is same as “Xmas”

3. State names “CALIFORNIA” can also be referred as “CA”, “COLORADO” can be represented as “CO”

4. Country name “United Kingdom” is synonymous to “Great Britain”

5. Celeb name “Jennifer Lopez” is also written as “JLo”

6. Category names “Music concerts” and “Concerts” refer to the same category.

A provider may give a static rank value to each event depending on the general popularity of the event. Providers may use various metrics to calculate this value and these can be in different ranges, Rank may be normalized to a range 0 to 1 such that all ranks are centered on a selected mean. The normalizer 210 may into account the standard deviation of rank values specific to a provider in this calculation.

Social data may be categorized into various domains and placed in a social index. Following are some examples:

1. Friend A has recommended stock quote MSFT→Domain Finance

2. Friend B has commented on weather in Seattle→Domain Weather

3. You have liked U2 events->Domain Events

4, Friend C has liked the celeb page of Lady Gaga→Domain Events

As an example, a user may open a Web page and performs a query “events in Seattle”. The search engine may boost rankings of events of a performer the user's friends have liked. In addition, the search engine may provide comments of the user's friends regarding weather in Seattle.

To obtain data from a social index, a domain may be specified. If query is made of the social index without specifying any domains, the search results may include data on Finance also as friends may have recommended some stocks. To avoid this problem, social data may be filtered on a user's domain and related domains. An exemplary query to a Social index is as follows:

Q={give me social data of user and his friends with user's social id=‘abc’ and domain=(‘events’ or ‘weather’)};

Determination of related domains may be determined by humans tasked with this job and/or by using machine learning techniques.

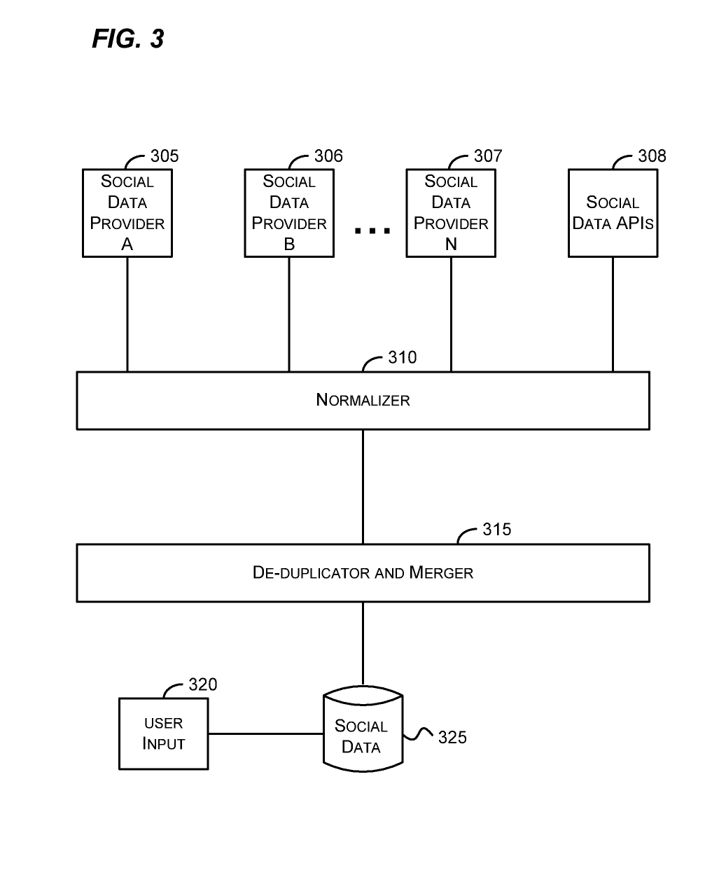

FIG. 3 is a block diagram that represents a data collector for social data in accordance with aspects of the subject matter described herein. The data collector of FIG. 3 may include social data providers 305-307, social data application programming interfaces (APIs) 308, a normalizer 310, a de-duplicator and merger 315, a user input component 320, a data store 325, and other components (not shown).

The social data providers 305-307 and the social data APIs 308 may provide data from social networks in different formats and using different schemes. The normalizer 310 takes this data and converts it into a common scheme. After converting the data to a common scheme, the normalizer 310 may provide the data to the de-duplicator and merger 315.

The de-duplicator and merger 315 combines the data provided to it and removes redundancies. For example, social data from two different providers may be merged into a table, other data structure, or other form (e.g., a text file such as a corpus) that includes social data. Duplicate data from multiple providers may be discarded.

The data produced by the de-duplicator and merger 315 may be stored in the data store 320 and published to a social index. The social index may include types of data including:

1. A social graph. A social graph may indicate relationships between people of a social network. A person may be represented in the social graph as a node with a social identifier (ID) and one or more connections to other nodes that represent other people of the person's social network. This social graph may be queried and provided with an ID and depth parameters. In response, the graph may be used to obtain identifiers of related nodes up to maximum depth specified in the query. For example, if depth parameter is 2, the graph can be used to determine “friends of friends” in addition to friends. A depth of 2 may be used for many scenarios, but other depths may also be used without departing from the spirit or scope of aspects of the subject matter described herein. In addition, multiple social networks may be represented by a single social graph.

2. User input data. A user may indicate a preference for certain types of events, performers, locations, and the like. In addition, a user may recommend events to the user's friends and acquaintances. This input data may be used to form a feedback loop. This feedback data may be represented in the social index.

In one embodiment, user input data may be collected by having recommend, like, or other user interface elements displayed next to an event listing in various search results. For example, a click on a button may be represented in the social index in the form of a social identifier and associated metadata. The metadata in the case of an event may include, for example, event id, name, start date, venue name, performer name, location, domain(events), or other data. This data may be queried on social identifier and the domain name.

3. Other social data. This other social data is in addition to the other event data and may be collected from social networking partner sites in the form of feeds. This other social data may include, for example, information of people who have linked to a page in a social network for an event.

4. Aggregated metadata. Aggregated metadata may include data such as how many people have liked a particular event, how many people have liked or recommended a particular performing group/venue, and the like.

A Queryable Data Structure. FIG. 3 is a block diagram that represents a data collection and aggregation system in accordance with aspects of the subject matter described herein. Through data aggregation, a queryable data structure may be created and updated that may be used to provide social signal ordered records in response to eventing queries. Social data and event data may be matched in a fuzzy manner for de-duplication. For example, some matching actions that may be used are as follows:

1. Event name and venue name may be matched in a fuzzy manner using a modified form of cosine dot product.

2. Date and location names are matched exactly.

3. Strings may be normalized before a match is performed. Normalization may remove special characters and convert a string into a canonical lower case format. Normalization may also account for synonyms, abbreviations, or other equivalents of venue names, performer names, locations, and the like. For example, HHH Metrodome and Humphrey H Metrodome may be normalized to the same venue.

4. Time data may be matched within a window.

Data in the data index and the social index may be updated at different times. For example, data derived from the user input component 320 may be used for updates in real time or near real time while social data from the social providers 305-307 and social data APIs may be updated twice a day or at some other frequency. Aggregated metadata may be computed at relatively shorter intervals (e.g., once every hour).

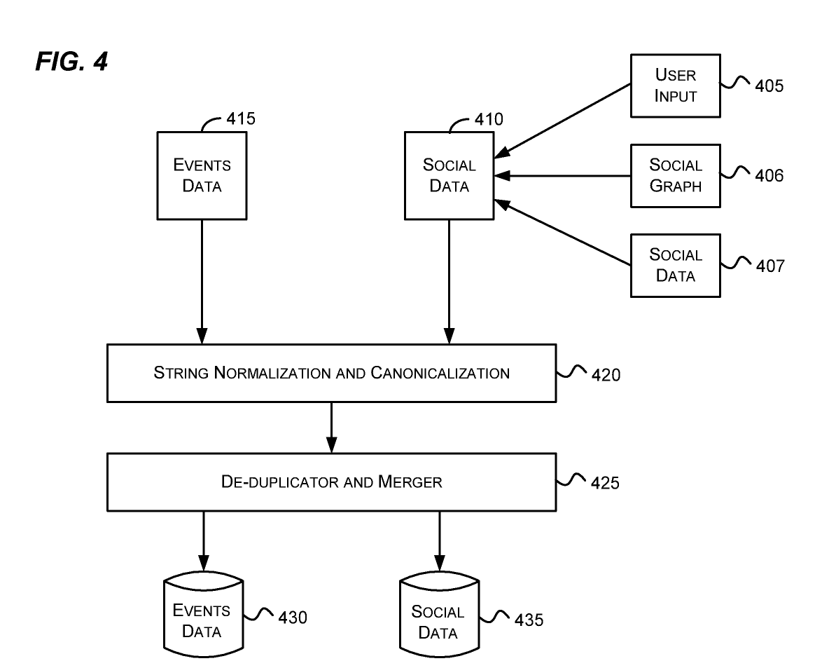

FIG. 4 is a block diagram that generally represents an exemplary system for collecting and aggregating data in accordance with aspects of the subject matter described herein. Turning to FIG. 4, the user input 405, social graph data 406, and other social data 407 may be aggregated into the social data 410. This may be done, for example, through the mechanisms described in conjunction with FIG. 3. The events data 415 may be collected as described in conjunction with FIG. 2. Aggregation of the events data 415 and the social data 410 may be performed by normalizing strings in the event data 415 and the social data 410 and converting the strings into canonical form through a component 420 that performs these actions.

The de-duplicator and merger 425 may remove duplicates and merge data by matching location, event name and venue, and time matching as described previously. The results of the events data 430 and the social data 435 may be aggregated into a queryable data structure that provides social signal ordered records for responding to eventing queries.

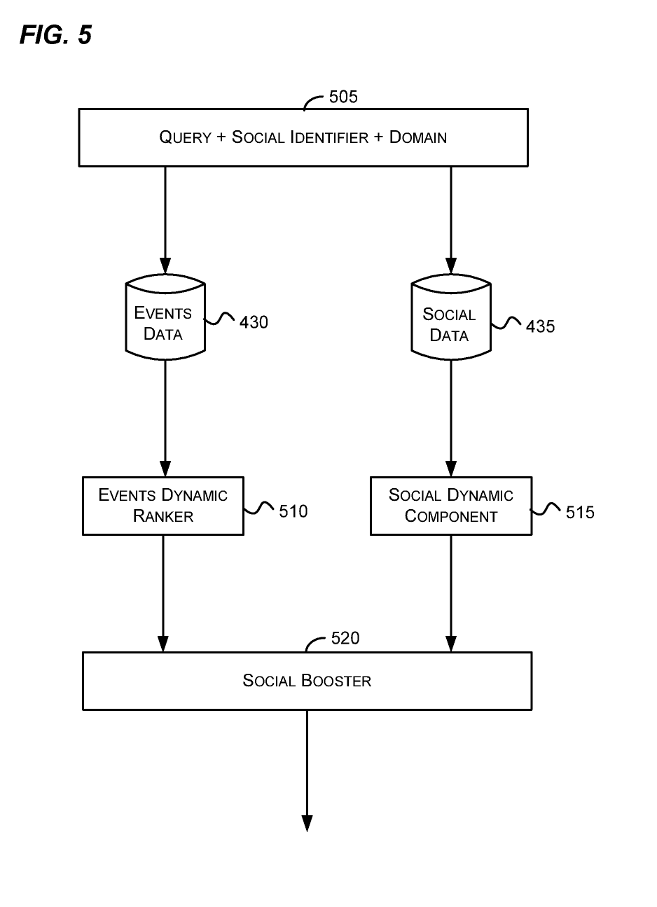

Overlaying results with personal data. FIG. 5 is a block diagram illustrating an exemplary system that combines static results with personal and dynamic information in accordance with aspects of the subject matter described herein. Static rank and dynamic rank may be used to search for data matching a user query. Static rank captures the overall popularity of an event and does not depend on the user query or location. Dynamic rank, on the other hand, may, for example, depend on the user query, closeness of user location to the event location, extent of query match in different event attributes such as name, category, description, and other attributes. Dynamic rank may also depend on static rank for one of its attributes.

An exemplary flow of events and data is as follows:

1. A query 505 that includes a social identifier and domain is sent to a search engine to search the events data 430 and social data 435.

2. The user query 505 is routed to an events dynamic ranker 510 and the social identifier and domain is sent to a social dynamic component 515.

3. The events dynamic ranker 510 uses the events data 430 and the use query 505 to order events based on dynamic rank. The events dynamic rank 510 may, for example, take into consideration factors including: static rank of event, closeness to user location, extent of query match in title, category, performers, venue, description, other data, and the like. The events dynamic ranker 510 sends identifiers and other related data of the ordered events to the social booster 520.

4. The social dynamic component 515 receives the social identifier and the domain and obtains metadata for the user's friend. The social dynamic component 515 uses the social data 435 to determine social data regarding the query. The social dynamic component 510 may, or example, take into consideration factors including number of likes, how active a user is in a social network, whether a user is a fan of a performer, other data, and the like. While the metadata may be configured for something other than events, in this example, the domain received by the social dynamic component 515 is one or more event identifiers. The social dynamic component 515 provides event identifiers of events indicated by friends (up to the indicated depth) and metadata so the social booster 520.

5. The social booster 520 matches event identifiers from data received from the events dynamic ranker 510 with event identifiers from the data received from the social dynamic component 515. Events that match are boosted in the ranking by the social booster 520.

6. Also, for the matching events, metadata is associated with the document before returning it to the querying source (e.g., a browser used by the user). This metadata contains the necessary information that a user interface component may use for differentiated rendering. For example, the user interface component may indicate that a particular event E is liked by a friend. A, another event is liked by a friend. B, and so forth.

Some of the actions above may occur in parallel with others of the actions. For example, the events dynamic ranker 510 and the social dynamic component 515 may perform actions in parallel.

As an optimization, social data may be maintained for a period of time after the social data is obtained. After the period of time elapses, the social data may be disposed of.

As another optimization, a social graph may be trimmed to maintain a list of active friends only.

User preferences may also be used to render a personalized experience in addition to social data. For example, if a user is a big fan of some performer A, events of that performer may be boosted in a ranking. Parameters of boosting rankings may be configurable.

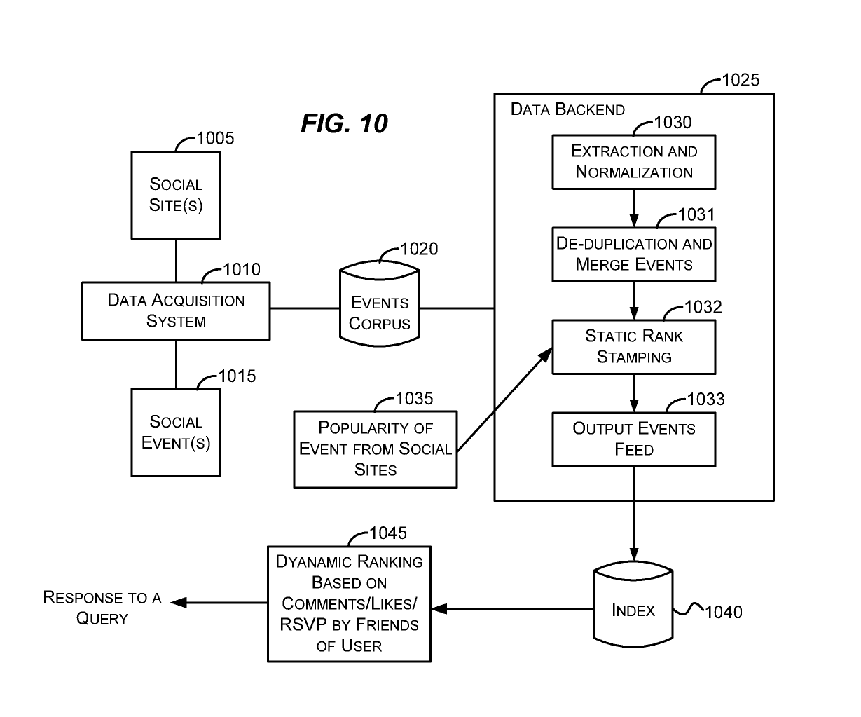

FIG. 10 is a block diagram that illustrates an exemplary system configured in accordance with aspects of the subject matter described herein. The system ties together some of the concepts presented above. The system includes an acquisition system 110 that acquires data from social site(s) 1005 and social event(s) 1015. The data acquisition system produces an events corpus 1020 that is provided to the data backend 1025.

The data backend extracts data and normalizes the data at block 1030. De-duplication and merging occurs at block 1031. Popularity of events from social sites 1035 is used to stamp events with a static rank at block 1032. Event data is outputted in an event feed to a queryable data structure 1040. The queryable data structure 1040 is used as input into a component that generates a dynamic rank of the search results based on one or more of comments, likes, RSVP by friends, personal preferences, other social data, and the like. This search result is returned in response to a query.

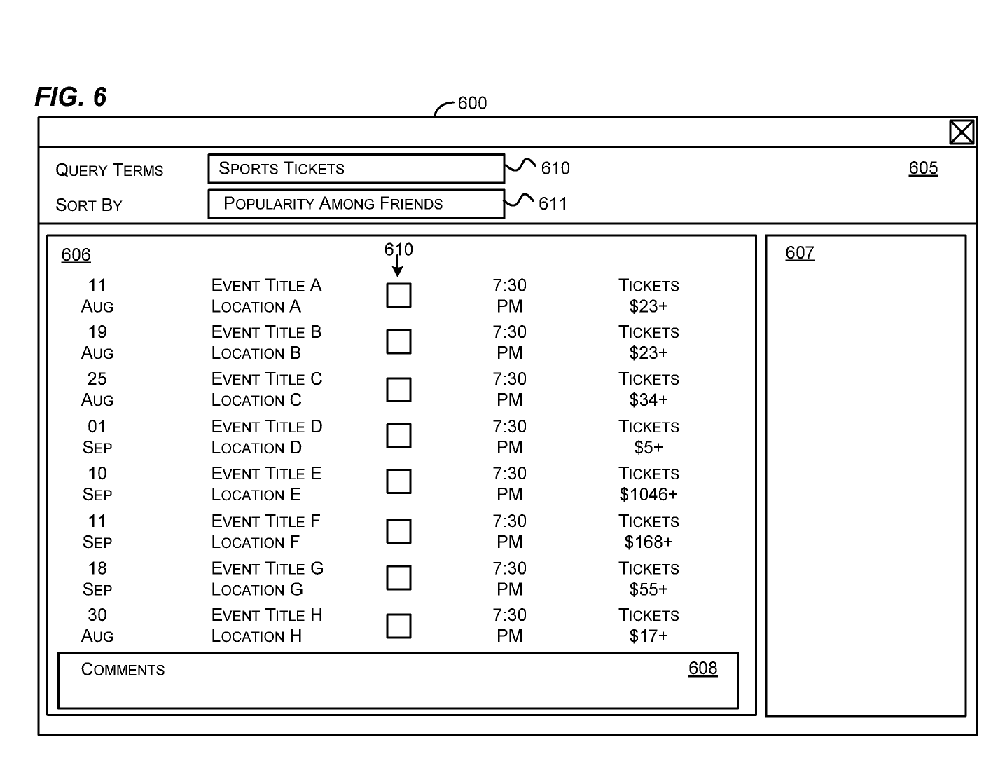

User Interface. FIG. 6 is a block diagram of an exemplary user interface window in accordance with aspects of the subject matter described herein. In one example, the window 600 may include areas 605-608. The area 605 may include a query input element 610 and a query sort element 611. The area 606 may display search results in an order in accordance with the order indicated by the query sort element 611. The area 607 may include advertisements. The area 608 may receive comments about an event and display comments from friends. The placement of the areas 605-608 and the data displayed therein is exemplary only. In other embodiments, there may be more, fewer, or different areas that display the same or other data than that indicated above.

The query sort element 611 may be used for receiving an indication of sort ordering for search results responsive to a query provided by the user through the query input element 610. The query sort element 611 may receive (e.g., from a user interacting with a browser) an indication of a sort ordering that is potentially based on social data.

As illustrated in FIG. 6, the query input element 610 indicates that a user wants to obtain search results for sports tickets while the query sort element 611 indicates that the results are to be sorted by popularity among friends. The query sort element 611 may be implemented as a drop down text box, a menu, a text box, some other graphical user interface element, or the like without departing from the spirit or scope of aspects of the subject matter described herein.

The query sort element 611 may indicate sorting by a personal preference (e.g., performer preference), events near an address obtained via the social data (e.g., the user's address), or otherwise.

In one embodiment, the area 607 or a portion thereof may display social network images of friends who are attending an event. For example, a person using a social network may upload a digital image that represents the person to the social network. The area 607 may display an aggregation of these digital images or images derived from these digital images in the area 607 for friends who are attending an event. If there is not enough space in the area 607 to display this aggregation of digital images, a graphical element may be displayed that allows a user to retrieve or scroll through additional images of friends who are attending an event. In one implementation, whenever a person buys a ticket for an event, their social identifier and an event identifier of the event may be stored in a database accessible by the search engine.

In one embodiment, the window 600 may include a graphical element that indicates the popularity of performers based on data from a social network. For example, a graphical element may indicate how many people of a social network of the user like a performer. The windows 600 may also include like controls 610 that allow a user to indicate whether the user likes a performer/event included in the search results.

In one embodiment, the window 600 may allow a user to view and post comments for an event returned by the search engine. For example, these comments may be entered and displayed in area 608. An entered comment may be provided from the area 608 to be stored in a database accessible by the search engine. This comment may then be aggregated with other comments about an event and provided in response to another query based relation to the issuer of a query via a social graph. The issuer of the query above is the user who submits the query via a Web browser of the like.

In one embodiment the window may have controls (e.g., a button, link, or the like) next to events of the search result in the area 606. A control may include a text box, grid control, tool bar, a list, box, combo box, button, icon, pane, panel, menu, sub menu, page control, link control, and many other controls as will be readily recognized by those skilled in the art. These controls may allow a user to indicate whether the user likes a social event included in the search results. A control may allow a user to request admission to social event included in the search results. A control may allow a user to purchase a ticket for a social event included in the search results. A control may cause another Web page to be displayed to perform certain actions such as those mentioned above.

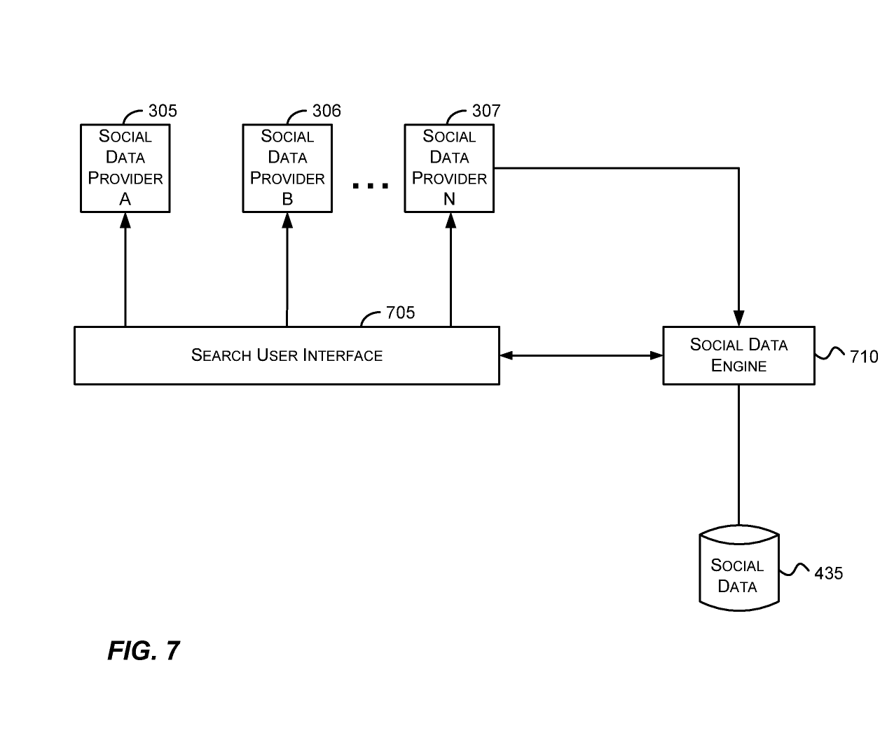

Cycle of data. FIG. 7 is a block diagrams that illustrates data sharing among a search engine, social data providers, and a search interface in accordance with aspects of the subject matter described herein. Actions a user takes captured by the search user interface 705 may be posted to the social data providers 305-307. For example, if a user indicates that the user likes an event, performer, or the like, this data may be posted to the social data providers 305-307. User preferences and data that indicates that a user has purchased a ticket to an event may also be posted to the social data providers 305-307. When the data is posted to the social data providers 305-307, it may become part of a repository of data that may be fetched by the social data engine 710. The social data engine 710 may use this data to update the social data 435 and to provide socially ordered results to the search user interface 705. This cycle may be beneficial to both the social providers 305-307 and the social data engine 710.

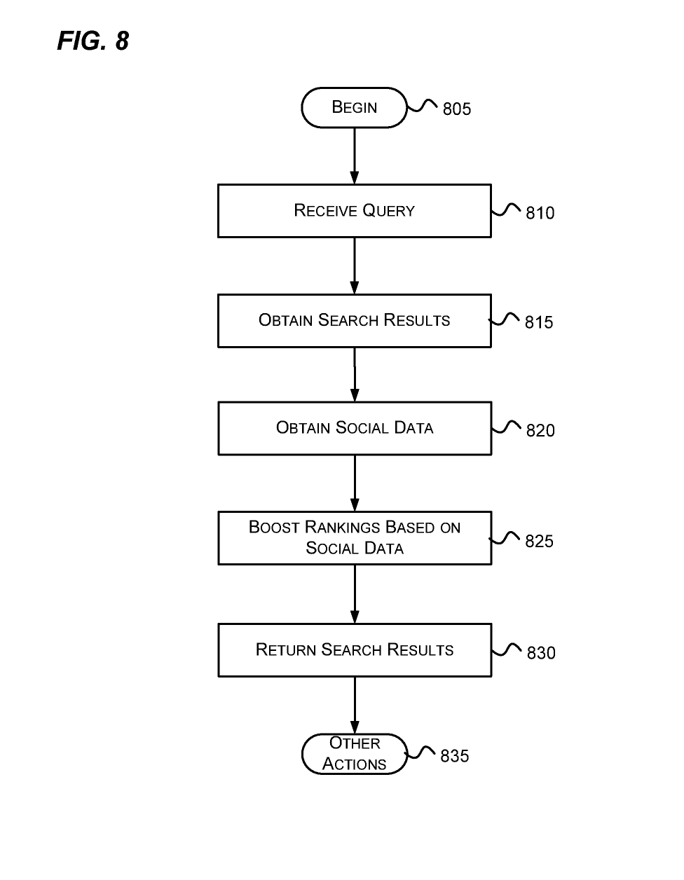

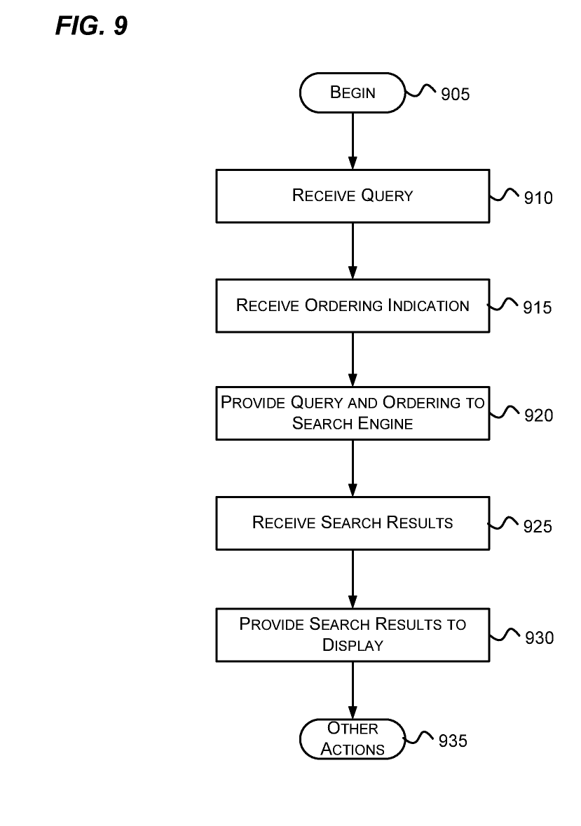

FIGS. 8-9 are flow diagrams that generally represent exemplary actions that may occur in accordance with aspects of the subject matter described herein. For simplicity of explanation, the methodology described in conjunction with FIGS. 8-9 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 8, at block 805, the actions begin. At block 810, a query is received. For example, referring to FIG. 5, a query 505 may be received at a component of a search engine. The query may indicate that the results are to be ordered based on social data, distance, or otherwise. The query may be received in conjunction with an identifier that identifies the issuer of the query (e.g., a person using a Web browser) to a social network. For example, the identifier may be a username or other identifier used in a social network.

At block 815, search results that are ranked based on popularity of the social event, are obtained. For example, referring to FIG. 5, the social booster 520 may receive data from an index that indicates a ranking of search results based on popularity of a social event, event indicated by the query 505. This data may have been compiled previously and placed in a queryable data structure (e.g., a database table searchable by index) by the mechanisms describe previously.

At block 820, social data is obtained. For example, referring to FIG. 5, social data is obtained by the social booster 520. Obtaining social data may include searching a social graph that indicates relationships between people of a social network. Searching the social graph may include searching to a specified depth from a node of the graph. The node may represent the person who issued the query.

Obtaining social data may include obtaining preferences of a user associated with an interface (e.g., a user interface of a Browser) supplying the query. Obtaining social data may also include obtaining data that indicates an event recommendation (e.g., likes) of a person (e.g., a friend or other connected person) of asocial network. This event recommendation may be provided in conjunction with providing the search results to a querying component such as a browser.

At block 825, a ranking of the search results based on social data is generated. This may include obtaining event identifiers associated with nodes of the graph within the depth from the node, matching the event identifiers with event identifiers associated with the search results that are ranked in a first order based on popularity of the social event, and boosting rankings of matched entries in the second order. For example, referring to FIG. 5, the social booster 520 may perform the actions indicated above.

At block 830, at least a portion of the search results and an indication of the ranking is provided. For example, the search results may be returned to a browser for display in the browser.

At block 835, other actions, if any, may be performed.

Turning to FIG. 9, at block 905, the actions begin. At block 910, a query is received. For example, referring to FIG. 6, a query may be received from the query input element 610.

At block 915, an indication is received of a social ordering by which search results are to be ordered. For example, referring to FIG. 6, an ordering indicating may be received from the query sort element 611.

At block 920, the query and indication of social order are provided to a search engine capable of ordering the search results in accordance with the social ordering. For example, referring to FIG. 10, the query may be provided to a search engine that has access to the queryable data structure 1040.

At block 925, search results are received from the search engine. The search results are ordered in accordance with the social ordering indicated in the query. For example, referring to FIG. 6, a response to the query is provided from the search engine to a browser represented by the window 600.

At block 930, the search results are provided to a display. For example, referring to FIG. 6, a browser component may render the results in area 606 and other social data such as comments, likes, and so forth in other places in the window 600.

At block 935, other actions, if any, may be performed.

As can be seen from the foregoing detailed description, aspects have been described related to social event searching. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents failing within the spirit and scope of various aspects of the subject matter described herein.

What is claimed is:

1. A method implemented at least in part by a computer, the method comprising:
receiving a query regarding a social event;
obtaining search results that are ranked in a first order based on popularity of the social event;
obtaining social data for the social event;
generating a ranking of the search results that indicates a second order based on the social data; and
providing at least a portion of the search results and an indication of at least a portion of the second order.

2. The method of claim 1, wherein the receiving a query regarding a social event comprises receiving data that indicates that the results are to be ordered based on the social data.

3. The method of claim 1, where receiving a query regarding a social event comprises receiving a social network identifier that identifies a person to a social network.

4. The method of claim 3, wherein generating a ranking of the search results that indicates a second order based on the social data comprises generating the ranking based on closeness of location of the social event to an address of the person indicated in the social data.

5. The method of claim 1, wherein obtaining search results that are ranked in a first order comprises obtaining search results that are ranked in the first order based also on extent of query match in title, category, performer, venue, and/or description.

6. The method of claim 1, wherein obtaining social data for the social event comprises searching a social graph that indicates relationships between people of a social network.

7. The method of claim 6, wherein searching a social graph that indicates relationships between people of a social network comprises searching to a specified depth from a node of the graph.

8. The method of claim 7, wherein generating a ranking of the search results that indicates a second order comprises obtaining event identifiers associated with nodes of the graph within the depth from the node, matching the event identifiers with event identifiers associated with the search results that are ranked in a first order based on popularity of the social event, and boosting rankings of matched entries in the second order.

9. The method of claim 1, wherein obtaining social data for the social event comprises obtaining preferences of a user associated with an interface supplying the query.

10. The method of claim 1, wherein obtaining social data for the social event comprises obtaining data that indicates an event recommendation of a person of a social network, the person related to a person issuing the query via a social graph.

11. The method of claim 1, further comprising providing event recommendations from the social data in conjunction with providing at least a portion of the search results.

12. In a computer system, a graphical user interface, comprising:
a first graphical interface element for receiving a query to submit to a search engine;
a second graphical interface element for receiving an indication of a sort ordering for search results responsive to the query, the sort ordering potentially based on first social data;
an area for displaying the search results in an order in accordance with the sort ordering; and
a third graphical interface element for receiving input that includes second social data to submit to the search engine.

13. The graphical user interface of claim 12, wherein the second graphical interface element comprises a drop down list box capable of displaying list items that correspond to a sort order based on popularity among friends, personal preference, or events near an address obtained from a social network.

14. The graphical user interface of claim 12, wherein the third graphical interface element comprises an area for receiving a comment about a social event, the comment to be provided to be stored in a database for use in at least in providing the comment in response to another query submitted to the search engine that returns results about the social event.

15. The graphical user interface of claim 12, wherein the third graphical interface element comprises an area or displaying comments about a social event from others who are related to an issuer of the query via a social graph.

16. The graphical user interface of claim 12, wherein the third graphical interface element comprises a control that allows a user to indicate whether the user likes a social event included in the search results.

17. The graphical user interface of claim 12, wherein the third graphical user interface element comprises a control that allows a user to request admission to a social event included in the search results.

18. The graphical user interface of claim 12, wherein the third graphical user interface element comprises a control that allows a user to purchase a ticket for a social event included in the search results.

19. A computer storage medium having computer-executable instructions, which when executed perform actions, comprising:
receiving a query to submit to a search engine that orders search results responsive to the query based on social data;
receiving an indication of a social ordering by which the search results are to be ordered;
providing the query and the indication of a social ordering to a search engine capable of ordering the search results in accordance with the social ordering;
receiving from the search engine search results responsive to the query and ordered in accordance with the social ordering; and
providing the search results to a display for displaying the search results.

20. The computer storage medium of claim 19, further comprising receiving a social comment regarding a social event included in the search results and providing the social comment to the search engine.
